(19) United States
(12) Patent Application Publication
(10) Pub. No.: US 2010/0132956 A1
(43) Pub. Date: Jun. 3, 2010

(54) EXPANDABLE CONNECTION WITH METAL TO METAL SEAL

(75) Inventors: Rodger LeBedz, Houston, TX (US); Richard Whiddon, Katy, TX (US)

Correspondence Address: Conley Rose, P.C, P.O. Box 3267, Houston, TX, 77253-3267, US

(73) Assignee: ENVENTURE GLOBAL TECHNOLOGY, L.L.C., Houston, TX (US)

(21) Appl. No.: 12/325,345

(22) Filed: Dec. 1, 2008

(51) Int. Cl. E21B 19/00; F16L 25/00

(52) U.S. Cl. 166/378; 285/332.2

(57) ABSTRACT

An expandable tubular connection includes coupled first and second tubular members and a sealing end on one of the first and second tubular members engaged with an angled shoulder coupled to the other of the first and second tubular members, wherein the sealing end deflects on the angled shoulder and plastically deforms into one of the first and second tubular members upon radial expansion and plastic deformation of the expandable tubular connection. A tubular sleeve including the angled shoulder may be coupled between the first and second tubular members. The sealing end may have an inner radial projection that is deflected into a surface on the first tubular member. A method includes pre-loading a sealing end of the second tubular member onto an angled shoulder of the tubular sleeve, radially expanding and plastically deforming the tubular connection, and deflecting the sealing end on the angled shoulder and into the first tubular member.

### BACKGROUND

This disclosure relates generally to hydrocarbon exploration and production and in particular to forming and repairing wellbore tubulars or casings to facilitate hydrocarbon exploration and production.

During hydrocarbon exploration, a wellbore typically traverses a number of zones within a subterranean formation. Wellbore casings are then formed in the wellbore by radially expanding and plastically deforming tubular members that are coupled to one another by threaded connections. Existing apparatus and methods for radially expanding and plastically deforming tubular members coupled to one another by threaded connections are not always reliable or produce satisfactory results. In particular, the threaded connections can be damaged during compressive loading and the radial expansion process. A damaged connection allows fluid and gas leakage.

The principles of the present disclosure are directed to overcoming one or more of the limitations of the existing processes for radially expanding and plastically deforming tubular members coupled to one another by threaded connections.

### SUMMARY

In some embodiments, an expandable tubular connection includes a first tubular member coupled to a second tubular member; and a sealing end on one of the first and second tubular members engaged with an angled shoulder coupled to the other of the first and second tubular members, wherein the sealing end is adapted to deflect on the angled shoulder and plastically deform into one of the first and second tubular members upon radial expansion and plastic deformation of the expandable tubular connection. In some embodiments, the sealing end includes a first axially aligned and compressively pre-loaded position prior to radial expansion and plastic deformation. The sealing end may also include a second offset and plastically deformed position after radial expansion and plastic deformation causing a seal.

In some embodiments, an expandable tubular connection includes a first tubular member, a second tubular member coupled to the first tubular member, the second tubular member including a sealing end having an inner radial projection, a tubular sleeve including an angled shoulder coupled between the sealing end and the first tubular member, wherein the sealing end engages the angled shoulder in a first axially aligned position and is moveable to a second offset position wherein the inner radial projection is deflected into a surface on the first tubular member. In some embodiments, the sealing end includes a reduced thickness portion having a bend in the second position, and the inner radial projection includes a corner plastically deformed in the second position.

In some embodiments, an expandable tubular connection includes a first tubular member including a threaded portion and an angled shoulder, a second tubular member including a sealing end and a threaded portion coupled with the first tubular member threaded portion, and a tubular sleeve including a flange having first and second angled shoulders, wherein the flange is coupled between the first tubular member angled shoulder and the sealing end, and the sealing end is radially moveably disposed on one of the flange angled shoulders. In some embodiments, upon radial expansion and plastic deformation of the connection, the sealing end is deflected on the tubular sleeve second angled shoulder and into the first tubular member. In further embodiments, the sealing end is plastically deformed into a plastically deformed cylindrical surface of the first tubular member.

In some embodiments, a method of sealing an expandable tubular connection includes coupling a first tubular member to a second tubular member, coupling a tubular sleeve to the first and second tubular members, pre-loading a sealing end of the second tubular member onto an angled shoulder of the tubular sleeve, radially expanding and plastically deforming the tubular connection, and deflecting the sealing end on the angled shoulder and into the first tubular member. Some embodiments include sliding a first curved surface on the sealing end along a second curved surface on the angled shoulder. Some embodiments include bending a reduced thickness portion of the sealing end. Some embodiments include plastically deforming an inner radial projection of the sealing end and plastically deforming a cylindrical surface of the first tubular member to cause a metal to metal seal.

### BRIEF DESCRIPTION OF THE DRAWINGS

For a more detailed description of the embodiments of the present disclosure, reference will now be made to the accompanying drawings, wherein:

FIG. 1 is a partial vertical sectional view through a well bore including a string of coupled tubular members run in the well bore prior to being expanded radially and plastically deformed;

FIG. 2A is an enlarged partial cross-sectional view of one of the tubular connections of FIG. 1, including the radial expansion and plastic deformation of a portion of the first tubular member;

FIG. 2B shows the radial expansion and plastic deformation of the connection of FIG. 2A;

FIG. 3A is an enlarged partial cross-sectional view of one of the tubular connections of FIG. 1 including a sleeve, and also including the radial expansion and plastic deformation of a portion of the first tubular member;

FIG. 3B shows the radial expansion and plastic deformation of the connection of FIG. 3A;

FIG. 4 is a partial section view of an embodiment of a tubular connection;

FIG. 5 is a partial section view of a pin end of the first tubular member of FIG. 4;

FIG. 6 is a partial section view of a box end of the second tubular member of FIG. 4;

FIG. 7 is a section view of the sleeve of FIG. 4;

FIG. 8 is a partial section view of another embodiment of a tubular connection;

FIG. 9 is an enlarged view of the box nose engagement of FIGS. 4 and 8; and

FIG. 10 is the box nose engagement of FIG. 9 including a seal after radial expansion and plastic deformation.

### DETAILED DESCRIPTION

In the drawings and description that follow, like parts are typically marked throughout the specification and drawings with the same reference numerals. The drawing figures are not necessarily to scale. Certain features of the disclosure may be shown exaggerated in scale or in somewhat schematic form and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed below may be employed separately or in any suitable combination to produce desired results.

In the following discussion and in the claims, the terms “including” and “comprising” are used in an open-ended fashion, and thus should be interpreted to mean “including, but not limited to . . . ”. Unless otherwise specified, any use of any form of the terms “connect”, “engage”, “couple”, “attach”, or any other term describing an interaction between elements is not meant to limit the interaction to direct interaction between the elements and may also include indirect interaction between the elements described. The terms “pipe,” “tubular member,” “casing” and the like as used herein shall include tubing and other generally cylindrical objects. The various characteristics mentioned above, as well as other features and characteristics described in more detail below, will be readily apparent to those skilled in the art upon reading the following detailed description of the embodiments, and by referring to the accompanying drawings.

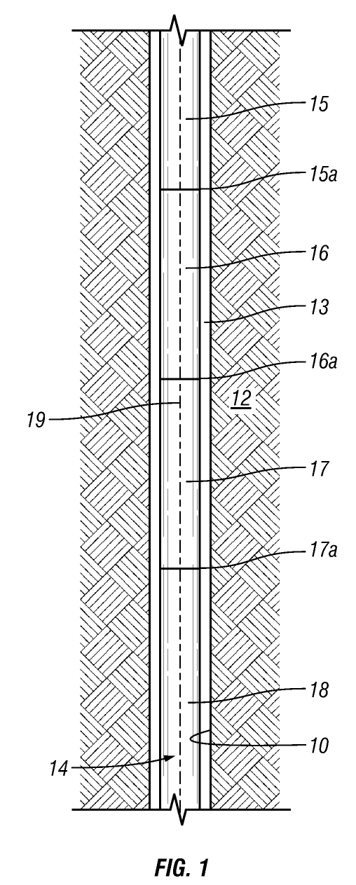

Referring initially to FIG. 1, a string 14 of coupled tubular members is disposed in a well bore 10 drilled through the formation 12, creating an annulus 13. The string 14 comprises a series of connected tubular members, such as casing joints 15, 16, 17 and 18, having a centerline or axis 19. In some embodiments, the casing joints are secured by connections 15a, 16a and 17a as indicated to form an elongate string that extends to the well surface. The casing string 14 is illustrated as being made up of individual casing joints of approximately 40 feet in length, for example, with a joint connection between the adjoining casing joints. In accordance with the principles of the present disclosure, the casing string 14 is to be radially expanded and plastically deformed into engagement with the surrounding well bore 10 using a forging device or expansion mandrel that passes internally through the casing string 14 and the connections 15a, 16a, and 17a.

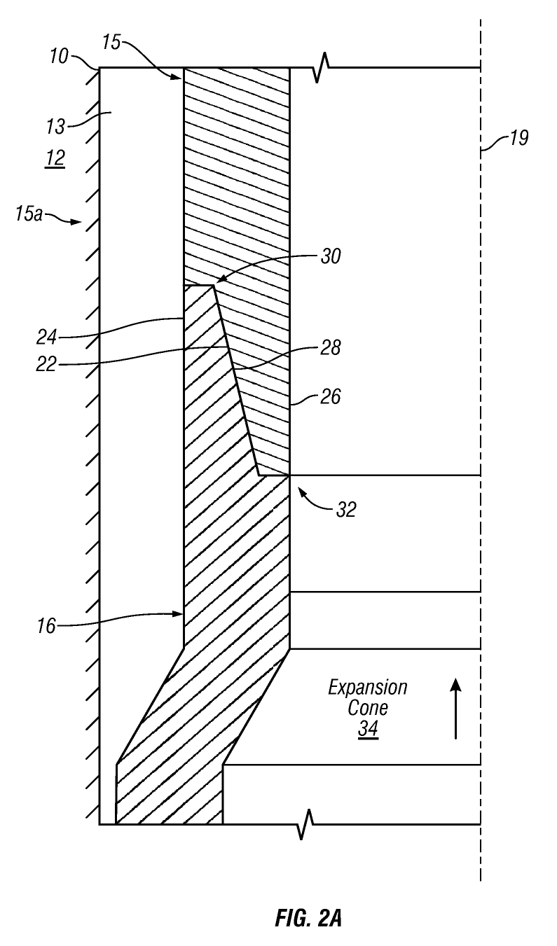

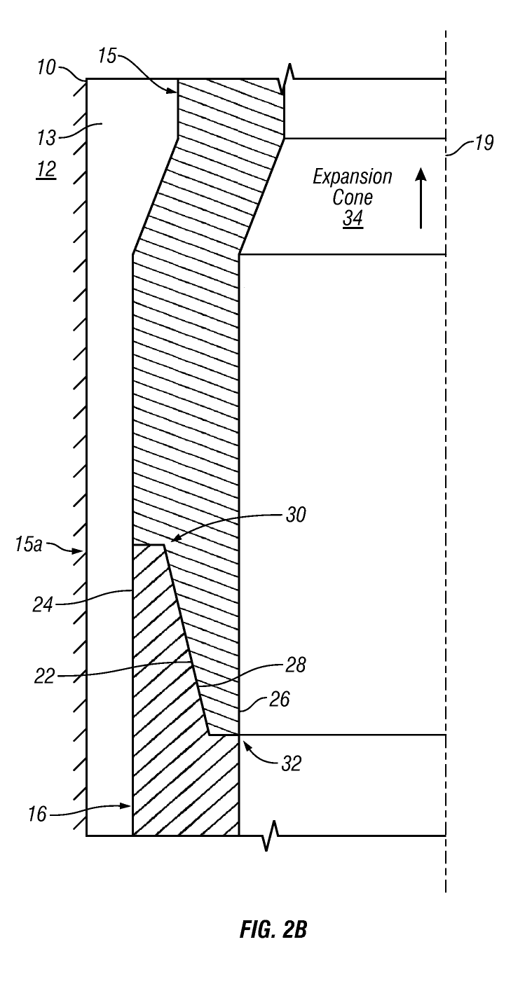

Referring now to FIG. 2A, the connection 15a of FIG. 1 is shown enlarged and in partial cross-section about the axis 19. The first tubular member 16 includes an internal connection surface 22 at an end portion 24. In some embodiments, the internal surface 22 includes threads. An external connection surface 28 of an end portion 26 of the second tubular member 15 is coupled to the internal connection 12 of the end portion 14 of the first tubular member 10. In some embodiments, the external surface 28 includes threads such that the surfaces 22, 28 are threadedly engaged. The first and second tubulars 16, 15 abut at locations 30, 32. In an exemplary embodiment, the internally threaded connection 22 of the end portion 24 of the first tubular member 16 is a box connection, and the externally threaded connection 28 of the end portion 26 of the second tubular member 15 is a pin connection.

In an exemplary embodiment, as illustrated in FIGS. 2A and 2B, the first and second tubular members 16, 15 may then be positioned within another structure 10 such as, for example, a wellbore, and radially expanded and plastically deformed, for example, by moving an expansion cone 34 through the interiors of the first and second tubular members. The movement of the expansion cone 34 through the interiors of the first and second tubular members 16, 15 may be from top to bottom or from bottom to top.

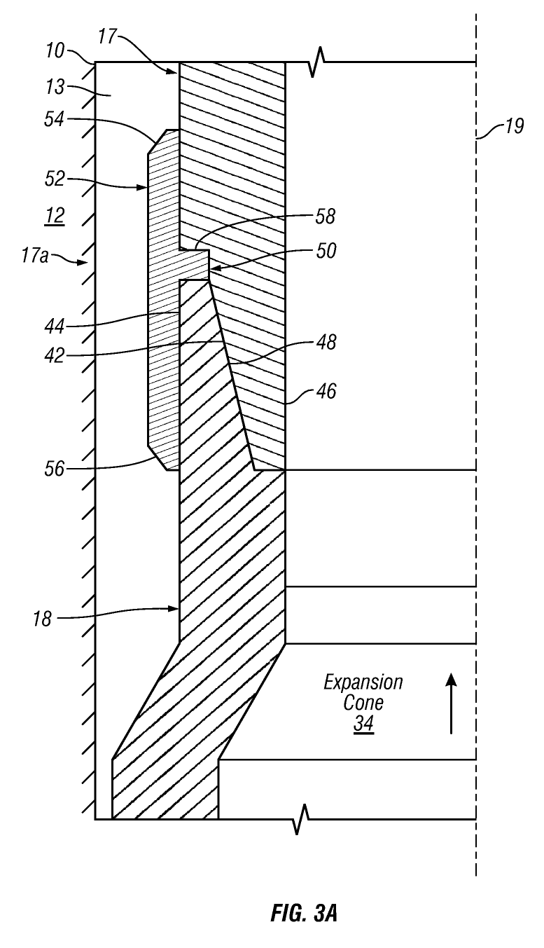

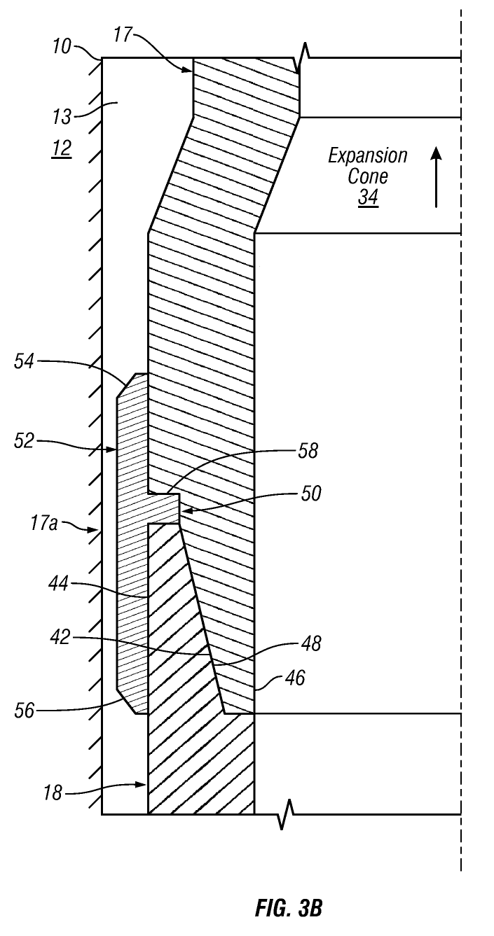

Certain connections may also include a sleeve. Referring next to FIG. 3A, the connection 17a of FIG. 1 is shown enlarged and in partial cross-section about the axis 19. A first tubular member 18 includes an internally threaded connection 42 at an end portion 44. A first end of a tubular sleeve 52 that includes an internal flange 58 and tapered portions 54, 56 at opposite ends is then mounted upon and receives the end portion 44 of the first tubular member 18. In an exemplary embodiment, the end portion 44 of the first tubular member 18 abuts one side of the internal flange 58 of the tubular sleeve 52. An externally threaded connection 48 of an end portion 46 of a second tubular member 17 having an annular recess 50 is then positioned within the tubular sleeve 52 and threadably coupled to the internally threaded connection 42 of the end portion 44 of the first tubular member 18. In an exemplary embodiment, the internal flange 50 of the tubular sleeve 52 mates with and is received within the annular recess 50. Thus, the tubular sleeve 52 is coupled to and surrounds the external surfaces of the first and second tubular members 18, 17. In an exemplary embodiment, the internally threaded connection 42 of the end portion 44 of the first tubular member 18 is a box connection, and the externally threaded connection 48 of the end portion 46 of the second tubular member 17 is a pin connection.

In an exemplary embodiment, as illustrated in FIGS. 3A and 3B, the first and second tubular members 18, 17 and the tubular sleeve 52 may then be positioned within another structure 10 such as, for example, a wellbore, and radially expanded and plastically deformed, for example, by moving an expansion cone 34 through the interiors of the first and second tubular members. The tapered portions 54, 56 of the tubular sleeve 52 facilitate the insertion and movement of the first and second tubular members within and through the structure 10, and the movement of the expansion cone 34 through the interiors of the first and second tubular members may be from top to bottom or from bottom to top. In an exemplary embodiment, during the radial expansion and plastic deformation of the first and second tubular members 18, 17, the tubular sleeve 52 is also radially expanded and plastically deformed. In an exemplary embodiment, as a result, the tubular sleeve 52 may be maintained in circumferential tension and the end portions 44, 46 of the first and second tubular members may be maintained in circumferential compression.

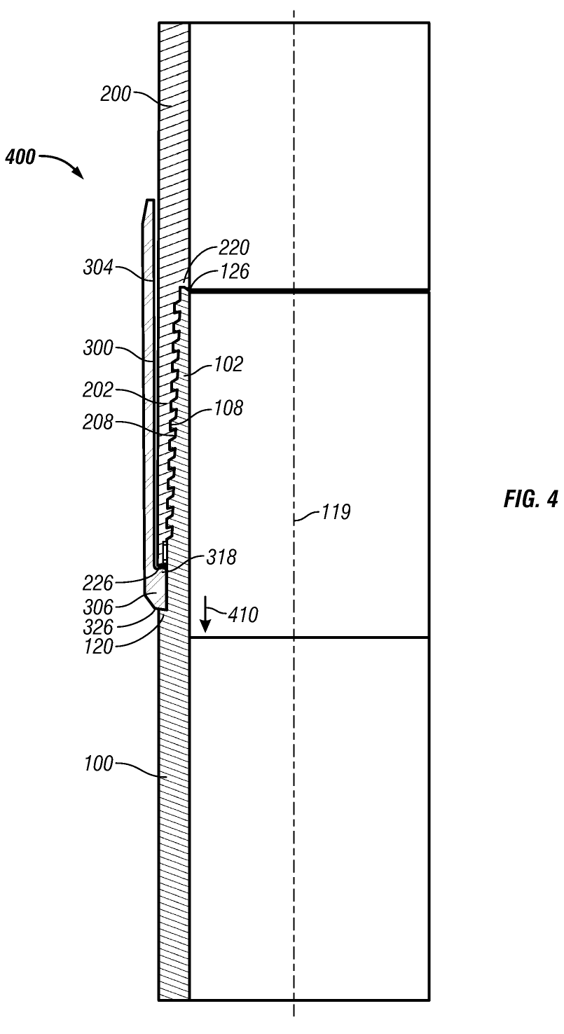

Referring to FIG. 4, an embodiment of a tubular connection 400 includes a first tubular member 100, a second tubular member 200 and a sleeve 300. The connection 400 and the tubular members 100, 200 include a longitudinal axis 119. The first and second tubular members are coupled at their ends 102, 202 by threaded engagement between the threads 108, 208. The tubular sleeve 300 overlaps and surrounds the threaded connection. The sleeve 300 includes a main portion 304 and an increased thickness portion 306 that is captured between the coupled tubulars 100, 200. The portion 306 is captured between shoulders of the coupled tubular members, 100, 200, assisting in coupling the sleeve 300 to the tubular members, as described in more detail below.

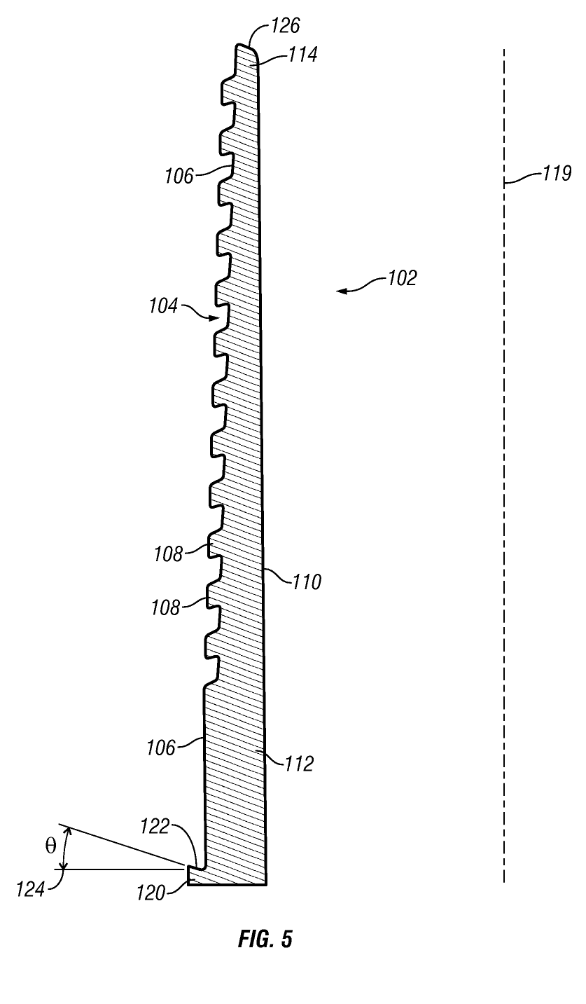

Referring to FIG. 5, a partial cross-section of the first end 102 of the first tubular member 100 is shown. The tubular member 100 includes the centerline or axis 119. In some embodiments, the end 102 is a pin end with a threaded portion 104. The threaded portion 104 includes an inner surface 106 with the threads 108 and an inner diameter surface 110. In some embodiments, the inner surface 106 includes a taper such that the threads 108 are tapered. Though the threads 108 include the thread profile geometry shown, other embodiments include various other thread profile geometries known in the art. At one end of the inner surface 106 is a shoulder 120 including a surface 122 having an offset angle θ from a radial plane 124. Axially displaced from the threaded portion 104 is an increased thickness portion 112 that is coupled to the main body section of the tubular 100. In another axial direction of the threaded portion 104 is an end portion 114 that extends from the threads 108. The end portion 114 includes an end surface 126 which may be angled.

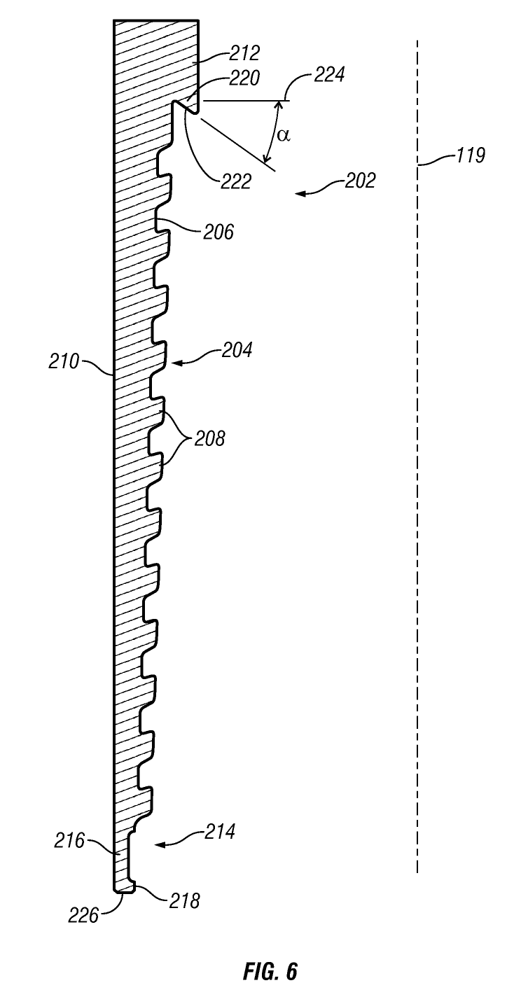

Referring to FIG. 6, a partial cross-section of the first end 202 of the second tubular member 200 is shown. The tubular member 200 includes the centerline or axis 119. In some embodiments, the end 202 is a box end with the threaded portion 204. The threaded portion 204 includes an inner surface 206 with the threads 208 and an outer diameter surface 210. In some embodiments, the inner surface 206 includes a taper such that the threads 208 are tapered. Though the threads 208 include the thread profile geometry shown, other embodiments include various other thread profile geometries known in the art. At one end of the inner surface 206 is a shoulder 220 including a surface 222 having an offset angle α from a radial plane 224. Axially displaced from the threaded portion 204 is an increased thickness portion 212 that is coupled to the main body section of the tubular 200. In another axial direction of the threaded portion 204 is an end portion 214 that extends from the threads 208. The end portion 214 includes a reduced thickness portion 216, an inner radial projection or lip 218 and an end surface 226.

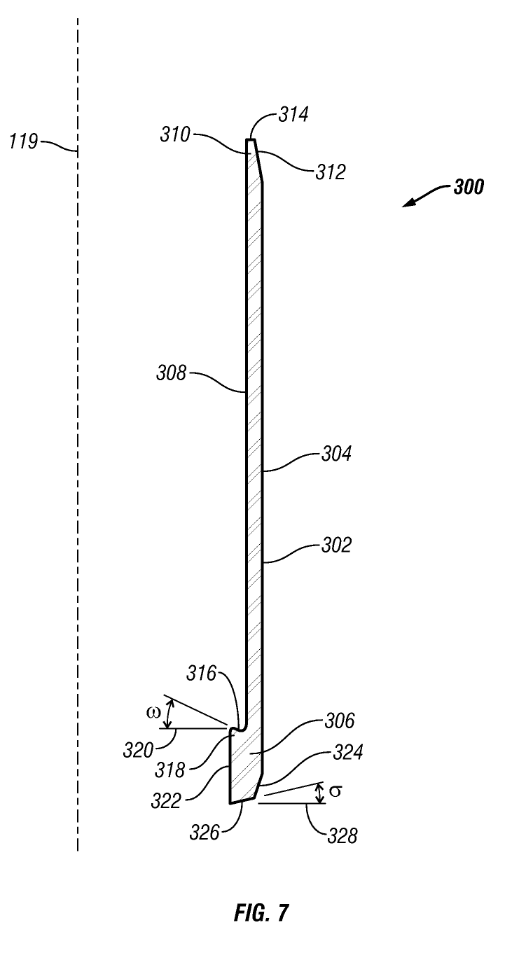

Referring to FIG. 7, a cross-section of the sleeve 300 is shown. The sleeve 300 includes the centerline or axis 119. The sleeve 300 includes an outer surface 302, the first portion 304 and the increased thickness portion 306. The first portion 304 includes an inner surface 308 and an end portion 310 having a tapered outer surface 312 and an end surface 314. The inner surface 308 transitions into a surface 316 at a shoulder 318 of the portion 306. The surface 316 includes an angle ω offset from a radial plane 320. The increased thickness portion 306 includes an inner surface 322, a tapered outer surface 324 and an end surface 326 including an angle α offset from a radial plane 328. The increased thickness portion 306 between the surfaces 316, 326 may also be referred to as a flange 306.

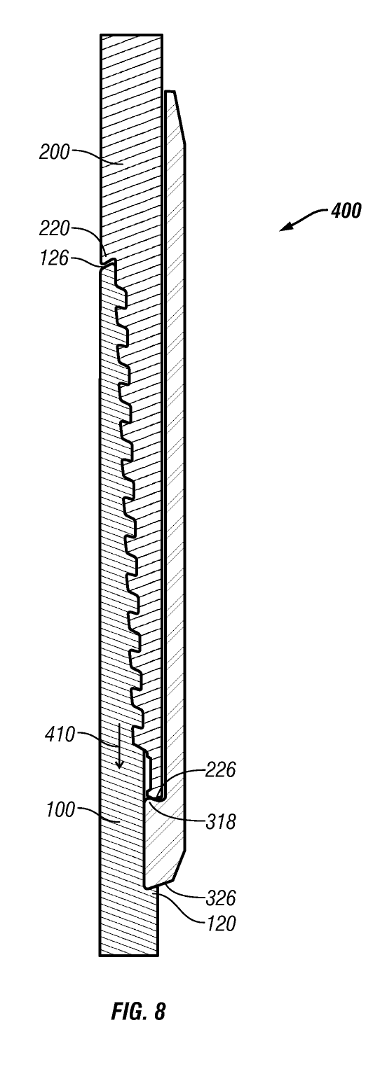

When the connection 400 is made up, as shown in FIG. 4, the angled end surface 326 of the sleeve 300 is disposed on the angled shoulder 120 of the pin end 102. The surface 226 of the end portion 214 of the box end 202 is disposed on the angled shoulder 318 of the sleeve 300. The surface 126 of the end portion 114 of the pin end 102 is disposed adjacent the angled shoulder 220 of the box end 202. In some embodiments, there is a gap between the surface 126 and the shoulder surface 222, as shown in FIG. 8. In other embodiments, contact between the surfaces 126, 222 may eliminate this gap. As the ends 102, 202 are torqued and made up, the pin end portion 114, or pin nose, is displaced into its position adjacent the angled shoulder 220 and the box end portion 214, or box nose, is compressed onto the angled shoulder 318 of the sleeve 300. The makeup torque provides a compressive force 410 causing the end surface 326 to seat onto the shoulder 120. Consequently, the flange 306 is captured between the tubular members 100, 200, thereby coupling the sleeve 300 to the tubular members.

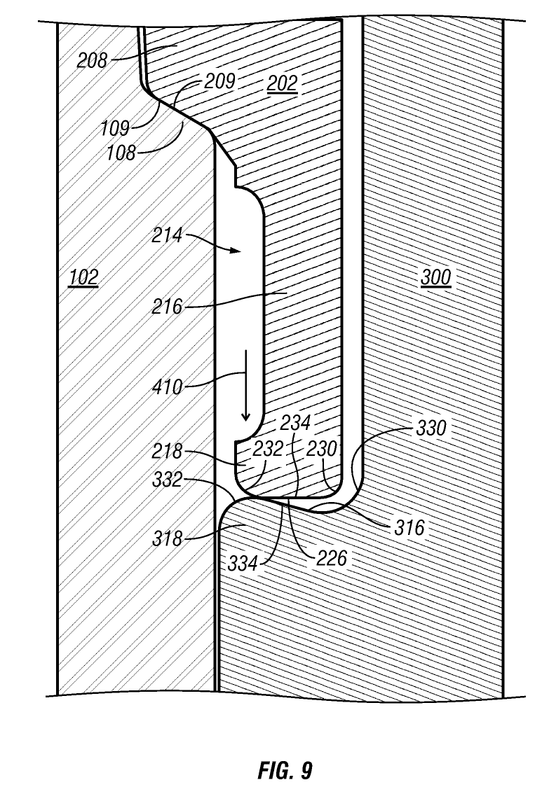

Referring to FIG. 9, an enlarged view of the box nose 214 engagement with the sleeve shoulder 318 of FIGS. 4 and 8 is shown. The makeup torque between the ends 102, 202 of the tubulars 100, 200 (shown as the abutting engagement of the surfaces 109, 209 of the threads 108, 208) creates a pre-loading compressive force 410 between the box nose 214 and the sleeve shoulder 318. The end surface 226 of the box nose 214 includes a first curved surface 230, a second curved surface 232 extending onto the projection or lip 218, and a straight surface 234 extending therebetween. The receiving surface 316 of the shoulder 318 includes a first curved surface 330, a second curved surface 332, and a straight surface 334 extending therebetween. In some embodiments, the surfaces 330, 332 are oppositely curved such that one is concave and the other is convex. In the compressive pre-load position of FIG. 9, the box end surface 226 adjacent the curved surface 232 contacts and presses against the sleeve surface 316 adjacent the curved surface 332. While the box nose or sealing end 214 is compressively loaded, it is also axially aligned with the other portions of the connection 400. In some embodiments, the box nose 214 includes slight deformation to pre-load the box nose 214 with the axial compressive force.

In the embodiments described with reference to FIG. 4-9, the axially aligned and pre-loaded position, prior to radial expansion, of the connection 400 includes an axial load path through the abutting surfaces 226, 316 as well as the additional axial load path provided by the engaged threads 108, 208. Consequently, the connection 400 is axially pre-loaded both at the engaged threads and at the box nose 214 and sleeve shoulder 318 engagement. Portions of the overall axial load capacity of the connection 400 are divided between these two locations, wherein the box nose location transmits a portion of the pre-expansion axial load and the threads transmit another portion of the pre-expansion axial load.

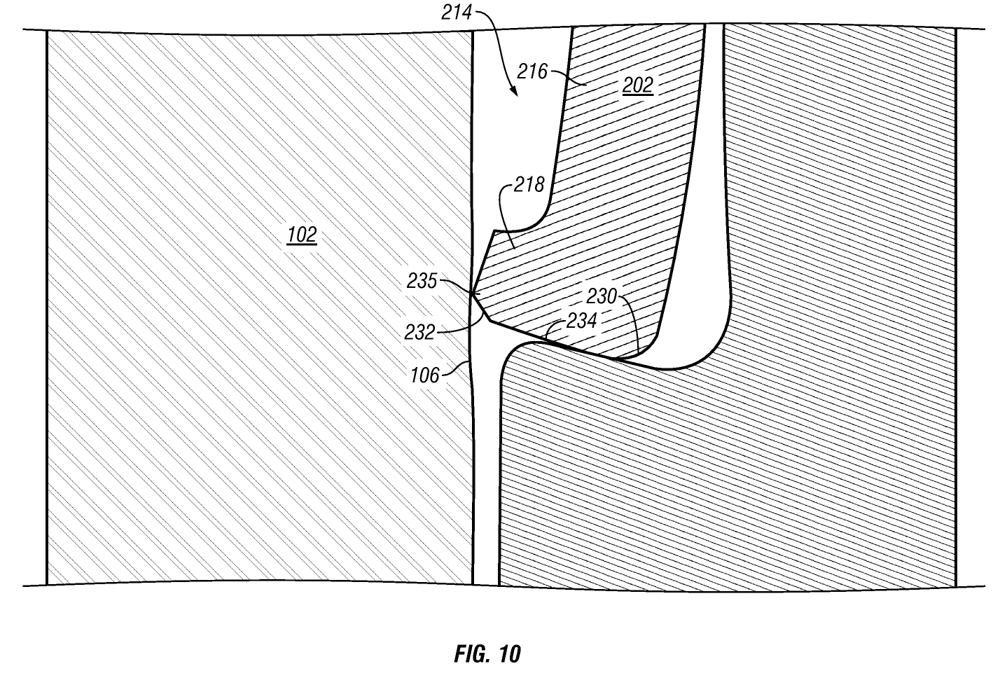

The pre-loaded connection 400 may be radially expanded and plastically deformed. Various known expansion systems may be used to radially expand the connection 400, such as those including a hydraulically driven mandrel or pig, or an anchored jack that is continually stroked through the tubular string 14. With reference to FIG. 10, the radial expansion force provides an additional compressive or axial load to the connection 400, causing the box nose 214 to move or bend radially inward. The curved surfaces 230, 232 on the box end surface 226 interact with and slide along the curved surfaces 330, 332 on the sleeve surface 316 to deflect the box nose 214 and force the projection 218 inward toward the surface 106 of the pin end 102. The reduced or necked portion 216 of the box nose 214 aids in the inward bending of the box nose 214. In the deflected or axially offset position shown in FIG. 10, portions of the flat surfaces 234, 334 compress against each other. A corner 235 on the projection then engages the cylindrical surface 106, and the corner 235 and the surface 106 plastically deform at these locations, thereby causing a seal.

The seal at 235 is formed because the residual stresses of radial expansion cause the uniquely shaped box nose to curl down and inward, and burrow into the cylindrical landing surface 106. The burrowing and plastic deformation of the edge 235 results in a robust contact pressure and resultant sealing capacity. In some embodiments, the location of the sealing end 214 comprising the reduced thickness portion 216, the inner projection or lip 218, and the curved end surface 226 is varied. In an exemplary embodiment, the sealing end 214, instead of being located at the box nose, is located at the pin nose 114 and compresses against the box end shoulder 220. Upon radial expansion, the corner edge 235 burrows into the box end surface 206 to plastically deform and cause a seal. In another exemplary embodiment, the sealing end 214 compresses against the pin end shoulder 120 instead of the sleeve shoulder 318, and seals as previously described by plastically deforming into a lower portion of the surface 106. In some embodiments, the sleeve 300 is coupled to the inner diameter 110 of the tubular members rather than the outer diameter. In some embodiments, the tubular members and the sleeve comprise metal, providing a metal to metal seal in the connection 400 at the plastically deformed edge 235 and localized surface 106. Furthermore, the angled shoulder 318 provides an angled interface for reacting the metal to metal seal. Another angled shoulder 120 provides a backing up force for the axial loading on the sleeve 300.

In some embodiments, the sleeve 300, in addition to having a portion 304 extending upward of the thicker portion 306, includes a similar portion extending downward from the portion 306 to increase the overall length of the sleeve 300. Such a full length sleeve would be similar to the sleeve 52 having two halves on each side of the flange 58. Referring to FIGS. 4 and 8, in one embodiment, the portion 304 of the sleeve 300 is mirrored about the portion 306 to approximately double the length of the sleeve 300 and extend the sleeve 300 downward onto the tubular member 100.

In some embodiments, the tubular members 100, 200 comprise various metals and other materials used in expandable tubulars. The sleeve 300 also comprises similar expandable metal materials. In other embodiments, certain portions of the connection 400 may comprise different material than other portions of the connection 400. For example, the box nose 214 or the pin nose 114 may comprise a different material as compared to the other portions of the tubulars 100, 200 and the connection 400.

In some embodiments, the various angled shoulders 120, 220, 318 provide increased back-up forces allowing greater makeup torque between the pin end 102 and the box end 202. The increased makeup torque provides a greater backout torque required to loosen, unthread or otherwise damage the pin and box end connection. Further resistance to bending forces and well bore tortuosity can also be achieved in these embodiments.

While the disclosure is susceptible to various modifications and alternative forms, specific embodiments are shown by way of example in the drawings and description. It should be understood, however, that the drawings and detailed description are not intended to limit the disclosure to the particular form disclosed, but on the contrary, the intention is to cover all modifications, equivalents and alternatives falling within the spirit and scope of the present disclosure.

What is claimed is:

1. An expandable tubular connection comprising:
a first tubular member coupled to a second tubular member; and
a sealing end on one of the first and second tubular members engaged with an angled shoulder coupled to the other of the first and second tubular members;
wherein the sealing end is adapted to deflect on the angled shoulder and plastically deform into one of the first and second tubular members upon radial expansion and plastic deformation of the expandable tubular connection.

2. The connection of claim 1 wherein the sealing end includes a first axially aligned and compressively pre-loaded position prior to radial expansion and plastic deformation.

3. The connection of claim 2 wherein the sealing end includes a second offset and plastically deformed position after radial expansion and plastic deformation causing a seal.

4. The connection of claim 1 wherein the sealing end includes an inner radial projection.

5. The connection of claim 1 wherein the sealing end includes a reduced thickness portion disposed between the inner radial projection and the body of the tubular member.

6. The connection of claim 4 wherein the inner radial projection includes a corner plastically deformed into a plastically deformed cylindrical tubular member surface.

7. The connection of claim 1 further comprising a tubular sleeve coupled to the first and second tubular members, wherein the tubular sleeve includes the angled shoulder.

8. The connection of claim 3 wherein the first and second tubular members comprise metal, and the seal is a metal to metal seal.

9. The connection of claim 1 wherein the sealing end includes a first curved surface slidably engaged with a second curved surface on the angled shoulder.

10. An expandable tubular connection comprising:
a first tubular member;
a second tubular member coupled to the first tubular member, the second tubular member including a sealing end having an inner radial projection; and
a tubular sleeve including an angled shoulder coupled between the sealing end and the first tubular member;
wherein the sealing end engages the angled shoulder in a first axially aligned position and is moveable to a second offset position wherein the inner radial projection is deflected into a surface on the first tubular member.

11. The connection of claim 10 wherein the sealing end is axially pre-loaded on the angled shoulder in the first position in response to a torque.

12. The connection of claim 10 wherein the sealing end includes a first curved surface slidably engaged with a second curved surface on the angled shoulder.

13. The connection of claim 12 wherein the first and second curved surfaces slide relative to each other during movement from the first position to the second position.

14. The connection of claim 10 wherein the sealing end includes a reduced thickness portion having a bend in the second position.

15. The connection of claim 10 wherein the inner radial projection includes a corner plastically deformed in the second position.

16. The connection of claim 10 wherein the first tubular member surface is a cylindrical surface that is plastically deformed by the inner radial projection in the second position.

17. The connection of claim 10 wherein the movement from the first position to the second position is in response to radial expansion and plastic deformation of the connection.

18. An expandable tubular connection comprising:
a first tubular member including a threaded portion and an angled shoulder;
a second tubular member including a sealing end and a threaded portion coupled with the first tubular member threaded portion; and
a tubular sleeve including a flange having first and second angled shoulders;
wherein the flange is coupled between the first tubular member angled shoulder and the sealing end; and
the sealing end is radially moveably disposed on one of the flange angled shoulders.

19. The connection of claim 18 wherein the connection is axially pre-loaded in response to a torque.

20. The connection of claim 18 wherein, upon radial expansion and plastic deformation of the connection, the sealing end is deflected on the tubular sleeve second angled shoulder and into the first tubular member.

21. The connection of claim 20 wherein the sealing end is plastically deformed into a plastically deformed cylindrical surface of the first tubular member.

22. A method of sealing an expandable tubular connection comprising:
coupling a first tubular member to a second tubular member;
coupling a tubular sleeve to the first and second tubular members;
pre-loading a sealing end of the second tubular member onto an angled shoulder of the tubular sleeve;
radially expanding and plastically deforming the tubular connection; and
deflecting the sealing end on the angled shoulder and into the first tubular member.

23. The method of claim 22 further comprising sliding a first curved surface on the sealing end along a second curved surface on the angled shoulder.

24. The method of claim 22 further comprising bending a reduced thickness portion of the sealing end.

25. The method of claim 22 further comprising plastically deforming an inner radial projection of the sealing end and plastically deforming a cylindrical surface of the first tubular member to cause a metal to metal seal.
